(19) United States
(12) Patent Application Publication
(10) Pub. No.: US 2016/0151775 A1
(43) Pub. Date: Jun. 2, 2016

(54) ION EXCHANGE PRODUCT AND MANNER OF USE

(71) Applicant: Norman B. Rainer, Richmond, VA (US)

(72) Inventor: Norman B. Rainer, Richmond, VA (US)

(21) Appl. No.: 14/998,586

(22) Filed: Jan. 27, 2016

Related U.S. Application Data
(60) Provisional application No. 62/282,934, filed on Aug. 17, 2015.

(51) Int. Cl. B01J 39/18; C02F 1/28; B01J 39/22; B01J 39/04; B01J 41/16; B01J 41/12

(52) U.S. Cl. CPC B01J 39/185; B01J 41/16; B01J 41/125; B01J 39/22; B01J 39/043; C02F 1/286; C02F 1/285; C02F 2101/20

(57) ABSTRACT

A cellulosic substrate is caused to have selective ion-exchange properties by way of contact with an aqueous protonated PEI solution followed by thermal treatment. The substrate is preferably in the form of a paper or a paper pulp which may be added to and retrieved from a body of polluted water.

### RELATED APPLICATIONS

This application is based upon Provisional Patent Application Ser. No. 62/282,934 filed Aug. 17, 2015, hereby incorporated herein by reference, and whose filing date is claimed as the filing date of the present Utility Patent Application.

### BACKGROUND OF THE INVENTION

1. Field of the Invention

This invention concerns a cellulosic product for the selective removal of dissolved ionic metal species from water, and the manner of producing and utilizing such product.

2. Description of the Prior Art

Because of natural geological factors or anthropogenic effects, most bodies of water will contain trace levels of ionically dissolved heavy metal species. Such species, generally at concentrations in the range of about 0.02 to 5 parts per million (ppm) are usually of toxicological concern. Of even greater concern are highly polluted industrial and municipal waste waters. The removal of such toxic species is generally complicated by the presence in the water of often high concentrations of innocuous species such as sodium, potassium, magnesium, calcium, nitrate, sulfate; phosphate, and chloride.

An often employed approach for the remediation of such polluted waters involves the use of absorbents having selective affinity for said trace metal species. In such procedures, the water to be treated is usually caused to flow through a confined permeable bed of bead-form ion-exchange material, generally produced from chemically modified polystyrene. However, the bead-form products are expensive, and require emplacement within dedicated columns having associated pumping equipment. Furthermore, metal-saturated polystyrene beads produce volatile toxic condensed ring hydrocarbon species when disposed of by way of incineration.

The desirability of incorporating into porous cellulose substrates substances having selective ion-exchange properties has earlier been recognized. For example, U.S. Pat. No. 5,002,984 discloses the incorporation into a cellulose sponge of a copolymer produced by the thermally induced condensation reaction of nitrilotriacetic acid (NTA) with polyethyleneimine (PEI). The PEI contains recurring primary, secondary and tertiary amine groups in a chain structure, and is known to absorb metal cations by way of formation of a coordination complex with its amine groups. The aforesaid incorporation process introduces up to 65% by weight of copolymer into said sponge, causing stiffening of the treated sponge and loss of compressibility. If forceably compacted, the copolymer splits away from the sponge.

Similarly, U.S. Pat. No. 8,809,227 discloses incorporation of the same copolymer into a cotton terrycloth fabric. The resultant fabric product is extremely stiff, and although useful in small pieces, has lost the flexibility needed for use in certain filtration applications. The same copolymer, when applied to cellulose filter paper, causes the resultant treated paper to lose the porosity requisite for filtration operations. When applied to soybean hulls, said copolymer splits away from the smooth outer surface of the hulls. In general, said applications have produced deposits of copolymer which are not chemically bound to the cellulose substrate. As such, the gross physical properties of the substrate are altered, and the copolymer content is removable by physical manipulation.

U.S. Pat. No. 4,332,916 to Thill discloses the grafting of PEI onto a cellulosic sponge employing a 100cc aqueous treatment solution containing 8 grams of PEI plus 6 grams of the cross linking agent 2-butenyl-bis [1,4 bis (2 hydroxyethyl) sulfoniom chloride]. Following treatment of said sponge with said solution, and subsequent thermal curing, washing, and drying, the treated sponge contained 10.9% PEI. It should be noted that such treatment involves a large amount of an expensive and toxic cross-linking agent.

In still other ways, it has been sought to associate PEI with cellulosic substrates, either in a removable manner such as a processing aide, or chemically joined to the cellulose by way of special bonding agents. It should be noted however, that the mere application of PEI (having a pH of about 12.0), to paper, followed by heating, produces decomposition of the PEI, forming a useless oily black composition.

The term “cellulosic” as used herein, is intended to denote substrates which are either entirely or primarily comprised of cellulose.

It is accordingly an object of the present invention to economically impart to a cellulosic substrate selective ion exchange properties by way of interaction with PEI without substantially changing the gross physical properties of the substrate.

It is another object of this invention to utilize the aforesaid treated cellulosic product in an original and efficient manner in the treatment of water having trace levels of dissolved toxic heavy metals.

These objects and other objects and advantages of the invention will be apparent from the following description.

### SUMMARY OF THE INVENTION

This invention is based in part upon the discovery that a protonated form of PEI, created by addition of acid species to PEI (to produce a pH in the range of 4.5 to 6.8), can undergo thermally induced chemical reaction with cellulose to import ion exchange properties without decomposition. Furthermore, by utilizing PEI of exceptionally high molecular weight, cellulose substrates thus treated, particularly paper and paper pulp, have sufficient ion exchange capacity to be of commercial value.

### BRIEF DESCRIPTION OF THE DRAWING

For a fuller understanding of the nature and objects of the invention, reference should be had to the following detailed description taken in connection with the accompanying drawing forming a part of this specification.

FIG. 1 is a side view, with portions broken away, showing apparatus for converting treated paper of the present invention into pulp form, and injecting said pulp into waste water flowing within a conduit.

### DESCRIPTION OF THE PREFERRED EMBODIMENT

Although not wishing to be bound by conjecture as to the chemical mechanism which would explain why a protonated amine would react with cellulose, it is felt that a few isolated carboxyl groups exist amongst the multitude of hydroxyl groups of the cellulose structure, and said carboxyl groups react with primary or secondary amine groups of the PEI (as shown in the formula below) to establish covalent amide chemical bonds that join the two entities.

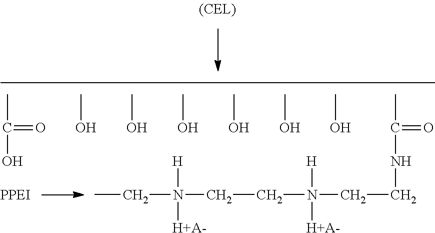

In the above formula, CEL represents cellulose, PPEI represents protonated PEI, and A− represents the anionic component of an acid species which may be an inorganic acid such as HCl or H₂SO₄, or an organic carboxylic acid.

The process for producing the cellulosic selective ion exchange product of the present invention starts with the preparation of an aqueous treatment solution containing dissolved PEI. A preferred concentration of PEI in the solution is in the range of 2% to 8%, producing an initial solution pH of about 12. It has been found that concentrations below 2% yield inadequate ion exchange functionality in a cellulose substrate. At concentrations above about 8%, it has been found that most of the PEI remains unreacted, presumably because of an absence of accepting reactive sites remaining in the cellulose.

The PEI-containing treatment solution is then treated with a strong mineral acid, preferably HCl, to produce protonated PEI and a solution pH in the range of about 4.5 to 6.8. At pH levels above 6.8, the solution leads to instability in a subsequent thermal curing process. At pH levels below about 4.5, reaction with cellulose has been found to be inefficient.

In certain embodiments, an organic polycarboxylic acid may be dissolved into the treatment solution prior to titration with a mineral acid. The effect of the polycarboxylic acid is to cross link PEI chains attached to the cellulose to produce a more robust add-on. When utilized, the amount of said polycarboxylic acid is preferably between about 20% and 70% of the weight of PEI. Suitable polycarboxylic acids include succinic acid, citric acid and tartaric acid. A particularily preferred polycarboxylic acid is nitrilotriacetic acid (NTA), which augments the metal-holding capacity of the PEI by providing chelation groups. It has been discovered that, although NTA is insoluble in plain water, it surprisingly remains dissolved in the treatment solution even after said solution is acidified to pH levels below 7.0.

The aforesaid treatment solution is then applied to a dry cellulosic substrate in a manner to achieve uniformity with minimal run-off. The solution-saturated substrate, whether a cellulosic paper capable of producing a pulp, or a pulp otherwise destined to produce a paper, is then subjected to a uniform heating operation. Heating temperatures in the range of 250° F. to 350° F. have been found suitable for time durations of about 60 to 15 minutes respectively. It is desirable, but not necessary to exclude oxygen from the space surrounding the treated substrate during heating, preferably by employing a stream of nitrogen gas. Paper materials treatable by the process of the present invention should have a wet tear strength of at least 20% of dry tear strength.

Following the aforesaid heat treatment, the product is washed with water to remove any unreacted substances. An alkaline substance may be incorporated into the wash water to adjust the substrate pH to about 7.0. If the product is left in an acidic state, it will have preferential affinity for anionic species.

It is preferred that the treated substrate contain an add-on of between 5% and 30% (dry weight basis) of PEI or PEI derivative. The expression “PEI derivative” is intended to include protonated PEI and PEI which has interacted with other species, most notably carboxylic acids. At add-on levels below 5%, the product is minimally effective for its intended ion exchange function. At add-ons above about 30%, the product may contain PEI or PEI derivatives which are not chemically bound to the intended cellulosic substrate, and will leach out in the course of use or in a pulping operation. The add-on level can be controlled by suitable variations in the concentration of the treatment solution and/or the amount of solution applied to the cellulosic substrate. The expression “chemically bound” is intended to denote covalent bond formation between two otherwise separate molecules.

Two expedients have been discovered to compensate for the relative lack of affinity of cellulose for PEI, and these expedients may be employed separately or sequentially. In one approach, the cellulosic substrate starting material is subjected to an oxidation treatment employing oxidizing agents such as ozone or hydrogen peroxide. In a second approach, the PEI is selected to have a molecular weight greater than 2,000, and preferably above 9,000.

The preferred cellulosic substrates to be treated in the aforesaid manner are produced from wood, as in a Kraft process, which produces a pulp, and a subsequent paper, which may be produced from said pulp. The pulp may be defined as an aggregation of a massive number of generally flat clusters of ⅛ to ½ inch size, each comprised of an intertangled assembly of cellulose fibers of varied length and of less than 50 um thickness. The fibers have a specific gravity of about 1.4, causing the clusters to sink in water.

When the treatment process of this invention is applied to paper, generally in the form of a continuous spirally wound length, heating operations would be provided by heated rollers or paired top and bottom rollers within an oven. When applied to pulp, heating operations are preferably provided by ovens which confine the pulp in vibrating trays. The treated paper product is best shipped to the site of use in dry, accordion folded stacks or as spirally wound rolls. Treated pulp may be shipped to the user in containers in a damp or dry form. When the treated substrate is a paper, it may be converted back into pulp form at the work site, employing equipment such as shredders or macerating devices equipped with rotating blades. The pulp thus produced may be directly entered into a body of water undergoing remediation. In other applications, paper having been treated by the process of this invention may be employed in filtration operations, whereby the paper will simultaneously remove suspended particulate and dissolved heavy metal species.

The treated cellulosic product of this invention has the ability to selectively absorb 60% to 90% of the dissolved cationic and anionic species it encounters within about 3-8 seconds. The specific rate of absorption is dependent upon the water temperature, pH, nature of the species sought, and presence and concentration of interfering species. At saturation, the product can hold between about 0.3% and 5.0% of its weight (dry weight basis) of absorbed species. Expressed alternatively, the product, whether in paper or pulp form, has an absorption capacity of about 1-2 milliequivalent(meq)/dry gram. For example, the treated pulp can absorb about 3.6% by weight of Cu+2, which represents about 1 meq of Cu⁺² per dry gram of pulp; plus 5% by weight of Hg⁺², which represents more than ½ meq of Hg⁺² per gram of treated pulp.

A further understanding of my invention will be had from a consideration of the following examples which illustrate certain preferred embodiments. It is to be understood that the instant invention is not to be construed as being limited by said examples or by the details therein.

### Example 1

An aqueous solution was made containing 4% by weight of PEI having a molecular weight of 10,000. (The PEI is a product of Nippon Shokubai of Japan). The solution was then titrated to pH 6.0 with conc. HCl. The resultant solution, considered a protonated PEI treatment solution, was applied to Bounty™ absorbent toweling paper, arranged in strip form, to cause thorough soaking without run-off.

The paper was then oven-treated @ 310° F. for 45 minutes, then spray-washed with tap water and dried. The resultant paper has an add-on weight of 4.3%, with unchanged water permeability or wet tear strength. Neither is there any change in the ease of conversion to a pulp format.

In a test for selective ion exchange properties, the treated sheets were converted into pulp using a kitchen-style blender device. The resultant pulp was poured into an absorption column of 2 inch inside diameter, whereby the pulp particles settled to form an absorption bed. A weighted grate was placed atop the bed to maintain a uniform bed density.

A test solution containing copper chloride, sodium chloride, calcium chloride, zinc chloride, mercury chloride and lead chloride was run through the pulp bed at a rate to provide a 20 second contact time. A blue/black absorption band formed and descended the bed. The effluent water emergent from the bed, upon testing, showed a 96% reduction in copper concentration, and reductions of 70% to 90% of zinc, mercury and lead. The sodium and calcium concentrations were unchanged, thereby illustrating the ionic selectivity of the treated pulp. A sample of the uppermost portion of the absorption band, presumably representing a saturated state, was taken for analysis, and found to contain 0.52% Copper.

### Example 2

Treatment solutions were prepared as in Example 1 with the addition of NTA, and having the characteristics and results shown in Table I. Each solution was applied to the aforesaid Bounty™ paper, which was then heat-treated and washed as in Example 1. The papers were then soaked in concentrated CuSO₄ solution to achieve absorption to saturation, then converted to pulp, re-washed, dried, and submitted for metal analysis. The copper saturation value does not represent the total capacity of the pulp absorbent for all ionic metals, but it does provide an indication of the effectiveness of production parameters.

TABLE I

| | | | | % Add-on | |
|---|---|---|---|---|---|
| Trial # | % PEI | % NTA | pH | weight | % Cu |
| 1 | 4.0 | 1.0 | 6.0 | 6.2 | 0.72 |
| 2 | 3.0 | 1.5 | 6.0 | 11.4 | 0.85 |
| 3 | 2.5 | 1.5 | 5.3 | 14.5 | 2.8 |
| 4 | 2.5 | 1.5 | 6.0 | 12.0 | 3.0 |
| 5 | 9.0 | 4.0 | 6.6 | 11.2 | 2.8 |

The data of Table I, in comparison with Example 1, demonstrate that the presence of NTA in the treatment solution increases the add-on weight with consequent increase in copper absorption. Furthermore, higher add-ons are produced with higher ratios of NTA/PEI. It also indicates that, even when the % PEI in the treatment solution is increased to 9%, as in Trial #5, there is no proportionate increase in the add-on weight. This further supports the concept of the present invention wherein the add-on is reasoned to be limited by a finite number of acceptor sites (such as carboxyl groups) in the cellulose structure. The unreacted PEI is removed in the washing operation.

### Example 3

The starting absorbent paper of Example 1 was moistened with water at pH 8, then treated with an oxidizing stream of 3% ozone in air until substantially dry. The resultant oxidized paper, having increased carboxyl groups, was then treated by the process of Example 1, using the treating solution of Trial #1 of Table 1. The resultant paper was found to have an add-on weight of 10.3%, and % copper uptake of 1.3%. Said increased values further indicate that attachment of protonated PEI to cellulose is dependent upon carboxyl groups in or attached to cellulose.

### Example 4

In order to ascertain the significance of the pH of the treating solution, a dried soft wood Kraft process pulp (Weyerhaeuser product CMC-320) was selected for treatment by a treatment solution having a PEI Concentration of 3%, a NTA/PEI ration of 0.6, and varied pH. The trials run and results obtained are shown in Table II.

TABLE II

| | | | | % Add-on |
|---|---|---|---|---|
| Trial # | % PEI | % NTA | pH | weight |
| 6 | 3 | 1.8 | 5.0 | 12.2 |
| 7 | 3 | 1.8 | 5.3 | 13.4 |
| 8 | 3 | 1.8 | 6.0 | 14.5 |
| 9 | 3 | 1.8 | 6.8 | 12.3 |
| 10 | 3 | 1.8 | 7.0 | 3.8 |

The data indicates that pH values between about 5 and 6.8 provide desired results. However, at pH 7, the protonated PEI tends to revert back to its free PEI state, and loses its affinity for cellulose. It has also been observed that Trial 10 produces a very dark brown coloration.

### Example 5

A significant use of the treated papers of the instant invention is in being converted back into pulp form and employed for the remediation of industrial and municipal waste waters. In such operations, the pulp material can be dumped on a regular or sporadic basis into the water. This is in essence opposite to prior art treatments of water with an absorbent species because, in the present invention, the absorbent material is caused to flow through the water, whereas, in prior art treatments, the water is caused to flow through the absorbent. Mechanical means may be employed to control the regularity of addition of the pulp material to flowing waters.

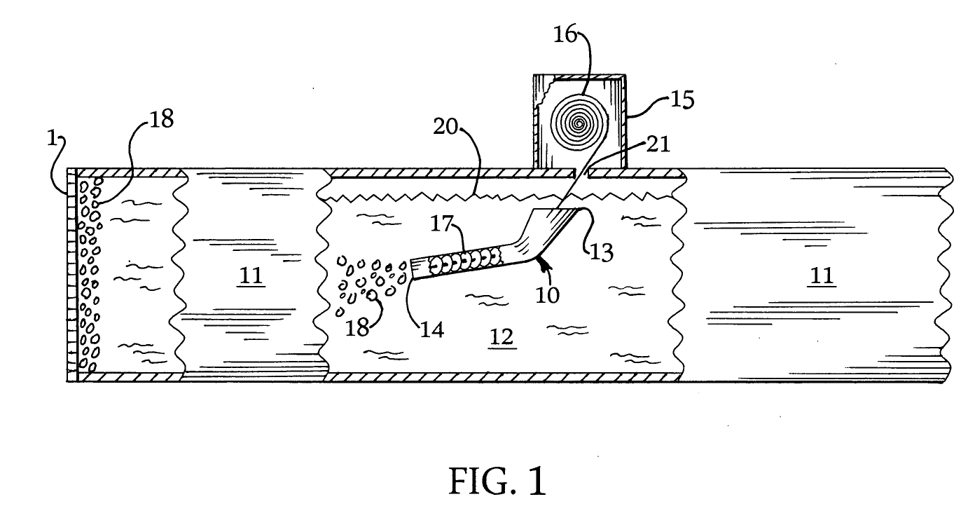

A preferred mechanical system is exemplified in FIG. 1, wherein a housed turbine-type pulp generating unit 10 is associated with a conduit 11 which conveys a non-pressurized flow of water 12. The pulp generating unit is angled between an upper, intake extremity 13, positioned below the surface 20 of the water and a lower, discharge extremity 14. An enclosure 15, mounted above said intake extremity, protectively confines a supply of treated paper 16 of this invention which may be in the form of a spirally wound roll, or a fan-folded stack. With appropriate controls, turbine 17, which may be powered by compressed air or electricity, draws the paper downwardly through slotted aperture 21 and into intake extremity 13. Passage of the paper through unit 10 produces an output of pulp particles 18. Said pulp particles selectively absorb ionized metal species from the water and accumulate upon a downstream filter unit 19, where their metal absorption function continues until saturation and/or periodic clean-out of the filter unit. In instances where the water which is undergoing remediation is non-flowing, such as a holding pond or reservoir, the pulp particles will settle to a bottom sediment accumulation, and maintain absorptive activity until the vacuuming or dredging of the sediment layer. Submerged baffles may be utilized to direct the sinking pulp particles to specific sites of accumulation.

While particular examples of the present invention have been shown and described, it is apparent that changes and modifications may be made therein without departing from the invention in its broadest aspects. The aim of the appended claims, therefore, is to cover all such changes and modifications as fall within the true spirit and scope of the invention.

Having thus described my invention, what is claimed is:

1) A selective ion exchange product comprised of a cellulosic substrate containing 5 to 30 percent by weight of chemically bound PEI or derivative thereof and capable of absorbing dissolved ionized toxic metal species from water containing greater amounts of non-toxic species, said absorption occurring at a reaction speed faster than 8 seconds, and said product having an absorption capacity greater than 1.0 meq of absorbed metal species per dry gram of said product.

2) The product of claim 1 wherein said substrate is a paper.

3) The product of claim 1 wherein said substrate is a pulp comprised of a multitude of clusters of ⅛ to ½ size, each comprised of interentangled cellulose fibers.

4) The product of claim 1 wherein said derivative of PEI is a reaction product of PEI with NTA.

5) The product of claim 4 wherein the amount of NTA is 20% to 70% of the weight of said PEI.

6) The product of claim 1 wherein said PEI has a molecular weight greater than 2,000.

7) The product of claim 6 wherein the molecular weight of said PEI is greater than 9,000.

8) The product of claim 2 wherein said paper has a wet tear strength at least 20% of its dry tear strength.

9) A process for imparting selective ion exchange properties to a cellulosic substrate comprising 1) treating said substrate with an aqueous solution containing 2 to 8% of PEI having a molecular weight greater than 2000, said solution being acidified to a pH between 4.5 and 6.8, 2) heating said treated substrate at 350° F. to 250° for about 15 to 60 minutes, respectively, to cause chemical attachment of PEI to said substrate, and 3) washing said heated substrate with water to remove any PEI not chemically attached to said substrate.

10) The process of claim 9 wherein said aqueous solution also contains a polycarboxylic acid.

11) The process of claim 9 wherein said wash water is alkaline in order to bring the washed substrate to a substantially neutral pH condition.

12) A process for utilizing the product of claim 1 to remove dissolved ionized metal species from a body of water, said process comprising: dispersing said product in a pulp state into said body of water, and collecting said pulp as an accumulation which provides extended contact time with the water and facilitates removal of said accumulation from said body of water.

13) The process of claim 12 wherein the product is in the form of a continuous length of paper which is drawn into a pulping apparatus and dispersed into said water.

14) The process of claim 13 wherein said body of water is flowing within a conduit, and the pulp is collected in downstream filtration means.

15) A product produced by the process of claim 9.

16) The process of claim 9 wherein the starting cellulosic substrate has previously undergone an oxidation treatment.

17) The product of claim 1 wherein said substrate is a filtration grade paper capable of simultaneously removing suspended particles and dissolved metal species from flowing water.

18) The process of claim 9 wherein said acidification is achieved, at least in part, with hydrochloric acid.

19) The process of claim 9 wherein the water employed for washing said treated paper has an alkaline pH.
